(19) United States
(12) Patent Application Publication
(10) Pub. No.: US 2014/0278389 A1
(43) Pub. Date: Sep. 18, 2014

(54) Method and Apparatus for Adjusting Trigger Parameters for Voice Recognition Processing Based on Noise Characteristics

(71) Applicant: Motorola Mobility LLC, Libertyville, IL (US)

(72) Inventors: Robert A. Zurek, Antioch, IL (US); Joel A. Clark, Woodbridge, IL (US); Pratik M. Kamdar, Gurnee, IL (US); Snehitha Singaraju, Gurnee, IL (US)

(73) Assignee: Motorola Mobility LLC, Libertyville, IL (US)

(21) Appl. No.: 14/142,177

(22) Filed: Dec. 27, 2013

Related U.S. Application Data
(60) Provisional application No. 61/776,793, filed on Mar. 12, 2013.
(60) Provisional application No. 61/798,097, filed on Mar. 15, 2013.
(60) Provisional application No. 61/827,723, filed on May 27, 2013.
(60) Provisional application No. 61/860,725, filed on Jul. 31, 2013.

(51) Int. Cl. G10L 15/22

(52) U.S. Cl. CPC G10L 15/22
USPC 704/231

(57) ABSTRACT

A method and apparatus for adjusting a trigger parameter related to voice recognition processing includes receiving into the device an acoustic signal comprising a speech signal, which is provided to a voice recognition module, and comprising noise. The method further includes determining a noise profile for the acoustic signal, wherein the noise profile identifies a noise level for the noise and identifies a noise type for the noise based on a frequency spectrum for the noise, and adjusting the voice recognition module based on the noise profile by adjusting a trigger parameter related to voice recognition processing.

### RELATED APPLICATIONS

The present application is related to and claims benefit under 35 U.S.C. §119(e) of the following U.S. Provisional patent applications: Ser. No. 61/776,793, filed Mar. 12, 2013, titled “Voice Recognition for a Mobile Device” (attorney docket no. CS41274); Ser. No. 61/798,097, filed Mar. 15, 2013, titled “Voice Recognition for a Mobile Device” (attorney docket no. CS41274); Ser. No. 61/827,723, filed May 27, 2013, titled “Voice Recognition for a Mobile Device” (attorney docket no. CS41274); and Ser. No. 61/860,725, filed Jul. 31, 2013, titled “Method and Apparatus for Adjusting Trigger Parameters for Voice Recognition Processing Based on Noise Characteristics” (attorney docket no. CS41951); which are commonly owned with this application by Motorola Mobility LLC, and the entire contents of each are incorporated herein by reference.

### FIELD OF THE DISCLOSURE

The present disclosure relates generally to voice recognition and more particularly to adjusting trigger parameters for voice recognition processing based on measured and inferred noise characteristics.

### BACKGROUND

Mobile electronic devices, such as smartphones and tablet computers, continue to evolve through increasing levels of performance and functionality as manufacturers design products that offer consumers greater convenience and productivity. One area where performance gains have been realized is in voice recognition. Voice recognition frees a user from the restriction of a device's manual interface while also allowing multiple users to access the device more efficiently. Currently, however, new innovation is required to support a next-generation of voice-recognition devices that are better able to overcome difficulties associated with noisy or otherwise complex environments that adversely affect voice recognition.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a device in accordance with some embodiments of the present teachings.

FIG. 2 is a block diagram of a device configured for implementing embodiments in accordance with the present teachings.

FIG. 3 is a logical flowchart of a method for determining a motion environment profile and adapting voice recognition processing in accordance with some embodiments of the present teachings.

FIG. 4 is a schematic diagram illustrating determining a motion environment profile and adapting voice recognition processing in accordance with some embodiments of the present teachings.

FIG. 5 is a table of transportation modes associated with average speeds in accordance with some embodiments of the present teachings.

FIG. 6 is a diagram showing velocity components for a jogger in accordance with some embodiments of the present teachings.

FIG. 7 is a diagram showing velocity components and a percussive interval for a runner in accordance with some embodiments of the present teachings.

FIGS. 8A and 8B are diagrams showing relative motion between a device and a runner's mouth for two runners in accordance with some embodiments of the present teachings.

FIG. 9 is a schematic diagram illustrating determining a temperature profile for a device in accordance with some embodiments of the present teachings.

FIG. 10 is a schematic diagram illustrating determining a motion profile for a device in accordance with some embodiments of the present teachings.

FIG. 11 is a logical flowchart of a method for determining the stationarity of noise to perform noise reduction in accordance with some embodiments of the present teachings.

FIG. 12 is a pictorial representation of three triggers related to voice recognition processing in accordance with some embodiments of the present teachings.

FIG. 13 is a pictorial representation of two trigger delays for a trigger related to voice recognition processing in accordance with some embodiments of the present teachings.

FIG. 14 is a logical flowchart of a method for determining a noise profile to perform a trigger parameter adjustment in accordance with some embodiments of the present teachings.

FIG. 15 is a logical flowchart of a method for determining a level and stationarity of noise to perform a trigger parameter adjustment in accordance with some embodiments of the present teachings.

FIG. 16 is a graph showing a functional dependence of a trigger threshold on a noise characteristic in accordance with some embodiments of the present teachings.

FIG. 17 is a graph showing a functional dependence of a trigger threshold on a noise characteristic in accordance with some embodiments of the present teachings.

FIG. 18 is a graph showing a functional dependence of a trigger delay on a noise characteristic in accordance with some embodiments of the present teachings.

FIG. 19 is a graph showing a functional dependence of a trigger delay on a noise characteristic in accordance with some embodiments of the present teachings.

FIG. 20 is a graph showing a functional dependence of a trigger threshold on a noise characteristic in accordance with some embodiments of the present teachings.

FIG. 21 is a graph showing a functional dependence of a trigger threshold on a noise characteristic in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for adjusting trigger parameters related to voice recognition processing. By compiling a noise profile, and in some embodiments integrating the noise profile with a motion profile to draw further inferences relating to noise characteristics, a device is able to more intelligently adjust trigger parameters related to voice recognition processing. In accordance with the teachings herein, a method performed by a device for adjusting a trigger parameter related to voice recognition processing includes receiving into the device an acoustic signal comprising a speech signal, which is provided to a voice recognition module, and comprising noise. The method further includes determining a noise profile for the acoustic signal, wherein the noise profile identifies a noise level for the noise and identifies a noise type for the noise, and adjusting the voice recognition module based on the noise profile by adjusting a trigger parameter related to voice recognition processing.

Also in accordance with the teachings herein is a device configured to perform voice recognition that includes at least one acoustic transducer configured to receive an acoustic signal that includes a speech signal and noise. The device also includes a voice-recognition module configured to perform voice recognition processing on the speech signal. The device further includes a processing element configured to determine a noise profile for the acoustic signal, wherein the noise profile identifies a level and stationarity of the noise. The processing element is also configured to adjust the voice recognition module by adjusting a trigger threshold related to voice recognition based on the noise profile, wherein the trigger threshold comprises at least one of a trigger threshold for phoneme detection, a trigger threshold for phrase matching, or a trigger for speaker verification.

For one embodiment, the processing element is further configured to adjust the at least one trigger threshold by making the at least one trigger threshold more discriminating when the noise is determined to be stationary relative to when the noise is determined to be non-stationary. In another embodiment, the processing element is further configured to adjust the at least one trigger threshold by making the at least one trigger threshold less discriminating when the level of noise is determined to be higher relative to when the level of noise is determined to be lower, wherein the adjusting is based on at least one of a step function of the level of noise or a continuous function of the level of noise.

Referring now to the drawings, and in particular FIG. 1, an electronic device (also referred to herein simply as a “device”) implementing embodiments in accordance with the present teachings is shown and indicated generally at 102. Specifically, device 102 represents a smartphone including: a user interface 104, capable of accepting tactile input and displaying visual output; a thermocouple 106, capable of taking a local temperature measurement; and right- and left-side microphones, at 108 and 110, respectively, capable of receiving audio signals at each of two locations. While the microphones 108, 110 are shown in a left-right orientation, in alternate embodiments they can be in a front-back orientation, a top-bottom orientation, or any combination thereof.

While a smartphone is shown at 102, no such restriction is intended or implied as to the type of device to which these teachings may be applied. Other suitable devices include, but are not limited to: personal digital assistants (PDAs); audio- and video-file players (e.g., MP3 players); personal computing devices, such as tablets; and wearable electronic devices, such as devices worn with a wristband. For purposes of these teachings, a device can be any apparatus that has access to a voice-recognition engine, is capable of determining a motion environment profile, and can receive an acoustic signal.

Referring to FIG. 2, a block diagram for a device in accordance with embodiments of the present teachings is shown and indicated generally at 200. For one embodiment, the block diagram 200 represents the device 102. Specifically, the schematic diagram 200 shows: an audio input module 202, motion sensors 204, a voice recognition module 206, a voice activity detector (VAD) 208, non-volatile storage 210, memory 212, a processing element 214, a signal processing module 216, a cellular transceiver 218, and a wireless-local-area-network (WLAN) transceiver 220, all operationally interconnected by a bus 222.

A limited number of device elements 202-222 are shown at 200 for ease of illustration, but other embodiments may include a lesser or greater number of such elements in a device, such as device 102. Moreover, other elements needed for a commercial embodiment of a device that incorporates the elements shown at 200 are omitted from FIG. 2 for clarity in describing the enclosed embodiments.

We now turn to a brief description of the elements within the schematic diagram 200. In general, the audio input module 202, the motion sensors 204, the voice recognition module 206, the processing element 214, and the signal processing module 216 are configured with functionality in accordance with embodiments of the present disclosure as described in detail below with respect to the remaining figures. “Adapted,” “operative,” “capable” or “configured,” as used herein, means that the indicated elements are implemented using one or more hardware devices such as one or more operatively coupled processing cores, memory devices, and interfaces, which may or may not be programmed with software and/or firmware as the means for the indicated elements to implement their desired functionality. Such functionality is supported by the other hardware shown in FIG. 2, including the device elements 208, 210, 212, 218, 220, and 222.

Continuing with the brief description of the device elements shown at 200, as included within the device 102, the processing element 214 includes arithmetic logic and registers necessary to perform the digital processing required by the device 102 to process audio data and aid voice recognition in a manner consistent with the embodiments described herein. For one embodiment, the processing element 214 represents a primary microprocessor of the device 102. For example, the processing element 214 can represent an application processor of the smartphone 102. In another embodiment, the processing element 214 is an ancillary processor, separate from a central processing unit (CPU), dedicated to providing the processing capability, in whole or in part, needed for the device elements 200 to perform their intended functionality.

The audio input module 202 includes elements needed to receive acoustic signals that include speech, represented by the voice of a single or multiple individuals, and to convert the speech into voice data that can be processed by the voice recognition module 206 and/or the processing element 214. For a particular embodiment, the audio input module 202 includes one or more acoustic transducers, which for device 102 are represented by the microphones 108 and 110. The acoustic transducers covert the acoustic signals they receive into electronic signals, which are encoded for storage and processing using codecs such as the G.711 Pulse Code Modulation (PCM) codec.

The block element 204 represents one or more motion sensors that allow the device 102 to determine its motion relative to its environment and/or motion of the environment relative to the device 102. For example, the motion sensors 204 can measure the speed of a device 102 through still air or measure the wind speed relative to a stationary device with no ground speed. The motion sensors 204 can include, but are not limited to: accelerometers, velocity sensors, air flow sensors, gyroscopes, and global positioning system (GPS) receivers. Multiple sensors of a common type can also take measurements along different axial directions. For some embodiments, the motion sensors 204 include hardware and software elements that allow the device 102 to triangulate its position using a communications network. In further embodiments, the motion sensors 204 allow the device 102 to determine its position, velocity, acceleration, additional derivatives of position with respect to time, average quantities associated with the aforementioned values, and the route it travels. For a particular embodiment, the device 102 has a set of motion sensors 204 that includes at least one of: an accelerometer, a velocity sensor, and air flow sensor, a GPS receiver, or network triangulation hardware. As used herein, a set is defined to consist of one or more elements.

The voice recognition module 206 includes hardware and/or software elements needed to process voice data by recognizing words. As used herein, voice recognition refers to the ability of hardware and/or software elements to interpret speech. In one embodiment, processing voice data includes converting speech to text. This type of processing is used, for example, when one is dictating an e-mail. In another embodiment, processing voice data includes identifying commands from speech. This type of processing is used, for example, when one wishes to give a verbal instruction or command, for instance to the device 102. For different embodiments, the voice recognition module 206 can include a single or multiple voice recognition engines of varying types that are best suited for a particular task or set of conditions. For instance, certain types of voice recognition engines might work best for speech-to-text conversion, and of those voice recognition engines, different ones might be optimal depending on the specific characteristics of a voice and/or conditions relating to the environment of the device 102.

The VAD 208 represents hardware and/or software that enables the device 102 to discriminate between those portions of a received acoustic signal that include speech and those portions that do not. In voice recognition, the VAD 208 is used to facilitate speech processing, obtain isolated noise samples, and to suppress non-speech portions of acoustic signals.

The non-volatile storage 210 provides the device 102 with long-term storage for applications, data tables, and other media used by the device 102 in performing the methods described herein. For particular embodiments, the device 102 uses magnetic (e.g., hard drive) and/or solid state (e.g., flash memory) storage devices. The memory 212 represents short-term storage, which is purged when a power supply for the device 102 is switched off and the device 102 powers down. In one embodiment, the memory 212 represents random access memory (RAM) having faster read and write times than the non-volatile storage 210.

The signal processing module 216 includes the hardware and/or software elements used to process an acoustic signal that includes a speech signal, which represents the voice portion of the acoustic signal. The signal processing module 216 processes an acoustic signal by improving the voice portion and reducing noise. This is done using filtering and other electronic methods of signal transformation that can affect the levels and types of noise in the acoustic signal and affect the rate of speech, pitch, and frequency of the speech signal. In one embodiment, the signal processing module 216 is configured to adapt voice recognition processing by modifying at least one of a frequency of speech, an amplitude of speech, or a rate of speech for the speech signal. For a particular embodiment, the processing of the signal processing module 216 is performed by the processing element 214.

The cellular transceiver 218 allows the device 102 to upload and download data to and from a cellular network. The cellular network can use any wireless technology that, for example, enables broadband and Internet Protocol (IP) communications including, but not limited to, 3^{rd} Generation (3G) wireless technologies such as CDMA2000 and Universal Mobile Telecommunications System (UMTS) networks or 4^{th} Generation (4G) or pre-4G wireless networks such as LTE and WiMAX. Additionally, the WLAN transceiver 220 allows the device 102 direct access to the Internet using standards such as Wi-Fi.

A power supply (not shown) supplies electric power to the device elements, as needed, during the course of their normal operation. The power is supplied to meet the individual voltage and load requirements of the device elements that draw electric current. The power supply also powers up and powers down a device. For a particular embodiment, the power supply includes a rechargeable battery.

We turn now to a detailed description of the functionality of the device 102 and device elements shown in FIGS. 1 and 2 at 102 and 200, respectively, in accordance with the teachings herein and by reference to the remaining figures. FIG. 3 is a logical flow diagram illustrating a method 300 performed by a device, taken to be device 102 for purposes of this description, for adapting voice recognition processing in accordance with some embodiments of the present teachings. Specifically, the device 102 receives 302 an acoustic signal that includes a speech signal. The speech signal is the voice or speech portion of the acoustic signal, that portion for which voice recognition is performed. Data acquisition that drives the method 300 is three-fold and includes the device 102 determining a motion profile, a temperature profile, and a noise profile at 304, 306, and 308 respectively. The device 102 collects and analyzes data in connection with determining these three profiles to determine if conditions related to the status of the device 102 will expose the device 102 to velocity-created noise or modulation effects that will hamper voice recognition.

The motion profile for the device 102 is a representation of the status of the device 102 and its environment as determined by data collected using the motion sensors 204. The motion profile includes both collected data and inferences drawn from the collected data that relate to the motion of device 102. In some embodiments, the device 102 also receives motion data from remote sources using its cellular 218 or WLAN 220 transceiver. For an embodiment, information included in the motion profile includes, but is not limited to: a velocity of the device 102, an average speed of the device 102, a wind speed at the device 102, a transportation mode of the device 102, and an indoor or outdoor indication for the device 102.

The transportation mode of the device 102, as used herein, identifies the method by which the device 102 is moving. Motor vehicle and airplane travel are examples of a transportation mode. Under some circumstances, the transportation mode can also represent a physical activity (e.g., exercise) engaged in by a user carrying the device 102. For example, walking, running, and bicycling are transportation modes that indicate a type of activity.

An indication of the device 102 being indoors or outdoors is an indication of whether the device 102 is in a climate-controlled environment or is exposed to the elements. A determination of whether the device 102 is indoors or outdoors as it receives the acoustic signal is a factor that is weighed by the device 102 in determining the type of noise reduction to implement. Wind noise, for instance, is an outdoor phenomenon. Indoor velocities are usually insufficient to generate a wind-related noise that results from the device 102 moving through stationary air.

An indoor or outdoor indication can also help identify a transportation mode for the device 102. Bicycling, for example, is an activity that is usually conducted outdoors. An indoor indication for the device 102 while it is traveling at a speed typically associated with biking would tend to suggest a user of the device 102 is traveling in a slow-moving automobile rather than riding a bike. An automobile can also represent an outdoor environment, as is the case when the windows are rolled down, for example. Other transportation modes, such as trains and airplanes, typically do not have windows that open and therefore consistently identify as indoor environments.

The temperature profile for the device 102 is a representation of the status of the device 102 and its environment as determined by temperature data that is both collected (e.g., measured) locally and obtained from a remote source. The temperature profile includes both collected data and inferences drawn from the collected data that relate to the temperature of device 102. For an embodiment, information included in the temperature profile includes a temperature indication. The temperature indication is an indication of whether the device 102 is indoors or outdoors as determined by a temperature difference between a temperature measured at the device 102 and a temperature reported for the location of the device 102. A further description of determining a temperature profile for the device 102 is provided with reference to FIG. 9.

The noise profile for the acoustic signal is a compilation of both collected data and inferences drawn from the collected data that relate to the noise within the acoustic signal. The noise profile created by the device 102 is compiled from acoustic information collected by one or more acoustic transducers 108, 110 for the device 102 (or sampled from the acoustic signal) that is analyzed by the audio input module 202, voice activity detector 208, and/or the processing element 214. For an embodiment, information included in the noise profile includes, but is not limited to: spectral and amplitude information on ambient noise, a noise type, noise level, and the stationarity of noise in the acoustic signal.

For one embodiment, the device 102 determines the type of noise to be wind noise, road noise, and/or percussive noise. The device 102 can determine a noise type by using both spectral and temporal information. The device 102 might identify wind noise, for example, by analyzing the correlation between multiple acoustic transducers (e.g., microphones 108, 110) for the acoustic signal. An acoustic event that occurs at a specific time has correlation between multiple microphones, whereas wind noise has none. A point-source noise (originating from a single point at a single time), such as a percussive shock, for instance, is completely correlated because the sound reaches multiple microphones in order of their distance from the point source. Wind noise, by contrast, is completely uncorrelated because the noise is continuous and generated independently at each microphone. In an embodiment, the device 102 also identifies and categorizes percussive noise as footfalls, device impacts, or vehicle impacts due to road irregularities (e.g., pot holes). A further description of percussive noise is provided with reference to FIG. 7, and a further description involving the stationarity of noise is provided with reference to FIG. 11.

From the motion, temperature, and noise profiles, the device 102 determines 310 a motion environment profile. Integrating information represented by the motion, temperature, and noise profiles into a single global profile, referred to herein as the motion environment profile, allows the motion environment profile to be a more complete and accurate profile than a simple aggregate of the profiles used to create it. This is because new suppositions and determinations are made from the combined information. For example, the motion, temperature, and noise profiles can provide separate indications of whether the device 102 is indoors or outdoors. A transportation mode might suggest an outdoor activity, while the noise profile indicates an absence of wind, and the temperature profile indicates an outdoor temperature. In an embodiment, this information is combined, possibly with additional information, to set an indoor/outdoor flag within the motion environment profile that is a more accurate representation of the indoor/outdoor status of the device 102 than can be provided by the motion, temperature, or noise profiles in isolation.

In one embodiment, settings or flags within the motion environment profile are determined from the motion, temperature, and noise profiles using look-up tables stored locally on the device 102 or accessed by it remotely. The device 102 compares values specified by the motion, temperature, and noise profiles against a predefined table of values, which returns an estimation of the motion environment profile for device 102. For example, if a transportation mode flag is set to “vehicular travel,” a wind flag is set to “inside” and a temperature flag is set to “inside,” the device 102 determines the motion environment profile to be enclosed vehicular travel. In another embodiment, the settings or flags within the motion environment profile are determined from the motion, temperature, and noise profiles using one or more programmed algorithms.

Based on the motion environment profile, the device 102 adapts 312 its voice recognition processing for the speech signal. Voice recognition processing is the processing the device 102 performs on the acoustic signal and the speech signal included in the acoustic signal for voice recognition. Adapting voice recognition processing is performed to aid or enhance voice recognition accuracy by mitigating adverse effects motion can have on the received acoustic signal. Motion related activities, for example, can create noise in the acoustic signal and cause modulation effects in the speech signal. A further description of motion-related modulation effects in the speech signal is provided with reference to FIGS. 8A and 8B.

FIG. 4 is a schematic diagram 400 illustrating the creation of a motion environment profile and its use in adapting voice recognition processing in accordance with some embodiments of the present teachings. Shown at 400 are schematic representations of: the motion profile 402, the temperature profile 404, the noise profile 406, the motion environment profile 408, signal improvement 410, noise reduction 412, and a voice recognition module change 414. More specifically, the diagram 400 shows the functional relationship between the illustrated elements.

For an embodiment, adapting voice recognition processing to enhance voice recognition accuracy includes the application of signal improvement 410, noise reduction 412, and a voice recognition module change 414. In alternate embodiments, adapting voice recognition processing includes the remaining six different ways to combine (excluding the empty set) signal improvement 410, noise reduction 412, and a voice recognition module change 414 (i.e., {410, 412}; {410, 414}; {412, 414}; {410}; {412}; {414}). Ina similar manner, the device 102 can draw on different combinations of the motion 402, temperature 404, and noise 406 profiles to compile its motion environment profile 408. In the specific embodiment shown at 400, the device 102 determines the motion environment profile 408 from a motion profile 402 and a temperature profile 404. In another embodiment, described further with reference to FIG. 13, the device 102 determines the motion environment profile 408 from the noise profile 406 and the motion profile 402. The device 102 uses the motion environment profile 408, in turn, to adapt voice recognition processing by improving the speech signal (also referred to herein as modifying the speech signal) and making a change to the voice recognition module 206 (also referred to herein as adapting the voice recognition module 206).

For one embodiment, adapting voice recognition processing for the speech signal includes modifying the speech signal before providing the speech signal to a voice recognition engine within the voice recognition module 206. For a particular embodiment, the device 102 determining the noise profile 406 includes the device 102 determining at least one of noise level or noise type, and the device 102 modifying the speech signal includes the device 102 modifying at least one phoneme within the speech signal based on at least one of the noise level or the noise type. As used herein, the noise level refers to the loudness or intensity of noise, which for an embodiment, is measured in decibels (dB). Having knowledge of the instantaneous velocities and accelerations of the device 102 as a function of time, for example, allows the device 102 to modify the speech signal to overcome the adverse effects of repetitive motion on the modulation of the speech signal, as described below with reference to FIGS. 8A and 8B.

For another embodiment, adapting voice recognition processing for the speech signal includes adapting the voice recognition module 206, which includes at least one of: selecting a voice recognition database; selecting a voice recognition engine; or changing operational parameters for the voice recognition module 206 based on the motion environment profile 408. In a first embodiment, the device 102 determines that a particular voice recognition database produces the most accurate results given the motion environment profile 408. The status and environment of the device 102, as described by the motion environment profile 408, can affect the phonetic characteristics of the speech signal. Individual phonemes, the phonetic building blocks of speech, can be altered either before or after they are spoken. In a first example, stress due to vigorous exercise (such as running) can change the way words are spoken. Speech can become labored, hurried, or even pitched (e.g., have a higher perceived tonal quality). The device 102 selects the correct voice recognition database for specifically the type of phonetic changes the current type of user activity (as indicated by the motion environment profile 408) causes. In a second example, the phonemes are altered after they are spoken, for instance, as pressure differentials, representing speech, move through the air and interact with wind, or due to the relative movement between a the user's mouth and the device 102 such as in a movement-based Doppler shift.

In a second embodiment, the device 102 determines that a particular voice recognition engine produces the most accurate results given the motion environment profile 408. A first voice recognition engine might work best, for example, when the acoustic signal includes a higher-pitched voice (such as a woman's voice) in combination with a low signal-to-noise ratio due in part to wind noise. Alternatively, a second voice recognition engine might work best when the acoustic signal includes a deeper voice (such as a man's voice) and does not include wind noise. In other embodiments, different voice recognition engines might be best suited for specific accents or spoken languages. In a further embodiment, the device 102 can download a software component of a voice recognition engine using its cellular 218 or WLAN 220 transceiver.

For a particular embodiment in which the device 102 includes a first and a second voice recognition engine, the device 102 adapts voice recognition processing by selecting the second voice recognition engine, based on the motion environment profile 408, to replace the first voice recognition engine as an active voice recognition engine. The active voice recognition engine at any given time is the one the device 102 uses to perform voice recognition on the speech signal. In a further embodiment, loading or downloading a software component of a voice recognition engine represents a new selection of an active voice recognition engine where the device 102 switches from a previously used software component to the newly loaded or downloaded one.

In a third embodiment, voice recognition processing performed by the voice recognition module 206 is affected by operational parameters set according to the motion environment profile 408 and/or the received acoustic signal. In a first example, changing an operational parameter for the voice recognition module 206 applies a gain to a weak speech signal. In a second example, changing an operational parameter for the voice recognition module 206 alters an algorithm used by the voice recognition module 206 to perform voice recognition. In a third example, changing an operational parameter for the voice recognition module 206 includes adjusting a trigger parameter for a trigger related to voice recognition processing. In addition to adjusting trigger parameters based on the motion environment profile 408, the trigger parameters can be adjusted based on the noise profile 406 alone in alternate embodiments. A description of trigger parameters related to voice recognition processing is provided with reference to FIGS. 11-21.

In other embodiments, adapting voice recognition processing includes changing a microphone, or a number of microphones, used to receive the acoustic signal. For a particular embodiment, a change of microphones is determined using an algorithm run by the processing element 214 or another processing core with the device 102. Further descriptions related to adapting the voice recognition module 206 are provided with reference to FIGS. 7 and 11.

In further embodiments, adapting voice recognition processing for the speech signal includes performing noise reduction. For one embodiment, the noise reduction applied to the acquired audio signal is based on an activity type (as determined by the transportation mode), the device velocity, and a measured and/or determined noise level. The types of noise reduced include wind noise, road noise, and percussive noise. To determine a type of noise reduction, the device 102 analyzes the spectrum and stationarity of a noise sample. For some embodiments, the device 102 also analyzes the amplitudes and/or coherence of the noise sample. The noise sample can be taken from the acoustic signal or a separate signal captured by one or more microphones 108, 110. The device 102 uses the VAD 208 to isolate a portion of the signal that is free of speech and suitable for use as an ambient noise sample.

For one embodiment, determining the noise profile 406 includes determining at least one of noise level or noise type. After determining the noise profile 406, the device 102 adapts voice recognition processing for the speech signal by suppressing the at least one of noise level or noise type within the acoustic signal. For example, where the noise profile indicates a continuous low-frequency noise, such as road noise, the device 102 determines the spectrum of the noise and adjusts a stop band in a band-rejection filter applied to the acoustic signal to suppress the noise.

For another embodiment, a determination that the noise is stationary or non-stationary determines a class of noise reduction employed by the device 102. Once a noise type is identified, based on spectral and temporal information, the device 102 applies an equalization or compensation filter specific to that type of noise. For example low frequency stationary noise, like wind noise, can be reduced with a filter or by using band suppression or band compression. For an embodiment, the amount of attenuation the filter or band suppression algorithm provides is based on sub-100 Hz energy measured from the captured signal. Alternatively when multiple microphones are used, the amount of suppression is based on the uncorrelated low-frequency energy from the two or more microphones 108, 110. A particular embodiment utilizes a suppression filter based on the transportation mode that varies suppression as a function of the velocity measured by the device 102. This noise-reduction variation, for example, shifts the filter corner based on speed of the device 102. In a further embodiment, the device determines its speed using an air-flow sensor and/or a GPS receiver.

In further embodiments, the level of suppression in each band is a function of the device 102 velocity and distinct from the level of suppression for surrounding bands. In one embodiment, noise reduction takes the form of a sub-band filter used in conjunction with a compressor to maintain the spectral characteristics of the speech signal. Alternatively, the filter adapts to noise conditions based on the information provided by sensors and/or microphones. A particular embodiment uses multiple microphones to determine the spectral content in the low-frequency region of the noise spectrum. This is useful when a transfer function (e.g., a handset-related transfer function) between the microphones is negligible. In this case, large differences for this spectral region may be attributed to wind noise or other low frequency noise, such as road noise. A filter shape for this embodiment can be derived as a function of multiple observations in time. In an alternate embodiment, the amount of suppression in each band is based on continuously sampled noise and changes as a function of time.

Another embodiment for the use of sensors to aid in the reduction of noise in the acquired acoustic signal uses the residual motion detected by an accelerometer in the device 102 to identify and suppress percussive noise incidents. Residual motions represent time-dependent velocity components that do not align with the time-averaged velocity for the device 102. In some instances, the membrane of a microphone will react to a large shock (i.e., an acceleration or time derivative of the velocity vector). The resulting noise depends on how the axis of the microphone is orientated with respect to the acceleration vector. These types of percussive events may be suppressed using an adaptive filter, or alternatively, by using a compressor or gate function triggered by an impulse, indicating the percussive incident, as detected by the accelerometer. This method aids significantly in the reduction of mechanical shock noise imparted to microphone membranes that acoustic methods of noise reduction cannot suppress.

For some embodiments of the method 300, the device 102 determining a motion profile includes the device 102 determining a time-averaged velocity for the device 102 and determining a transportation mode based on the time-averaged velocity. For a first embodiment, the device 102 uses the processing element 214 to determine the time-averaged velocity over a time interval from a time-dependent velocity measured over the time interval. As used herein, velocity is defined as a vector quantity, and speed is defined as a scalar quantity that represents the magnitude of a velocity vector. In one embodiment, the time-dependent velocity is measured using a velocity sensor at particular intervals or points in time. In another embodiment the time-dependent velocity is determined by integrating acceleration, as measured by an accelerometer of the device 102, over a time interval where the initial velocity at the beginning of the interval serves as the constant of integration.

For a second embodiment, the device 102 determines its time-averaged velocity using time-dependent positions. The device 102 does this by dividing a displacement vector by the time it took the device 102 to achieve the displacement. If the device 102 is displaced one mile to the East in ten minutes, for example, then its time-averaged velocity over those ten minutes is 6 miles per hour (mph) due East. This time-averaged velocity does not depend on the actual route the device 102 took. The time-averaged speed of the device 102 over the interval is simply 6 mph without a designation of direction. In a further embodiment, the device 102 uses a GPS receiver to determine its position coordinates at the particular times it uses to determine its average velocity. Alternatively, the device 102 can also use network triangulation to determine its position.

The average velocity represents a consistent velocity for the device 102, where time-dependent fluctuations are cancelled or averaged out over time. The average velocity of a car navigating a road passing over rolling hills, for instance, will indicate its horizontal (forward) motion but not its vertical (residual) motion. It is the average velocity of the device 102 that introduces acoustic noise to the acoustic signal and that can modulate a user's voice in a way that hampers voice recognition. Both the average velocity and the residual velocity, however, provide information that allows the device 102 to determine its transportation mode.

FIG. 5 shows a table 500 indicating five transportation modes, each associated with a different range of average speeds for the device 102, consistent with an embodiment of the present teachings. When the motion profile 402 indicates an average speed for the device 102 of less than 5 mph, the motion environment profile 408 indicates walking as the transportation mode for the device 102. Conversely, an average speed of more than 90 mph indicates the device 102 is in flight. The range of average speeds shown for vehicular travel is between 25 mph and 90 mph. For the embodiment shown, the range of average speeds for running (5-12 mph) and biking (9-30 mph) overlap between 9 mph and 12 mph. An average speed of 8 mph indicates a user of the device 102 is running. An average speed of 10 mph, however, is indeterminate based on the average velocity alone. At this speed, the device 102 uses additional information in the motion profile 402 to determine a transportation mode.

For a particular embodiment, the device 102 uses position data in addition to speed data to determine a transportation mode. Positions indicated by the device's GPS receiver, for example, when taken collectively, define a route for the device 102. In a first instance, the route coincides with a rail line, and the device 102 determines the transportation mode to be a train. In a second instance, the route coincides with a waterway, and the device 102 determines the transportation mode to be a boat. In a third instance, the route coincides with an altitude above ground level, and the device 102 determines the transportation mode to be a plane.

For an additional embodiment, determining a motion profile for the device 102 includes determining a transportation mode for the device 102, and the transportation mode is determined based on a type of application being run on the device 102. Certain applications run on device 102, for example, might concern exercise, such as programs that monitor cadence, heart rates, and speed while providing a stopwatch function, for example. When an application specifically designed for jogging is running on the device 102, it serves as a further indication that a user of the device 102 is in fact jogging. In another embodiment, the time-dependent residual velocity is used to determine the transportation mode for otherwise indeterminate cases and also to ensure reliability when average speeds do indicate particular transportation modes.

FIG. 6 shows a diagram 600 of a user jogging with the device 102 in accordance with some embodiments of the present teachings. The diagram 600 also shows time-dependent velocity components for the jogger (and thus for the device 102 being carried by the jogger) at four points 620-626 in time. At a time corresponding to the jogger's first position 620, the device 102 has an instantaneous (as measured at that point in time) horizontal velocity component v₁ₕ 602 and a vertical component v₁ᵥ 604. For the jogger's second 622, third 624, and fourth 626 positions, the horizontal velocity components are v₂ₕ 606, v₃ₕ 610, and v₄ₕ 614, while the vertical velocity components are v₂ᵥ 608, v₃ᵥ 612, and v₄ᵥ 616, respectively. The jogger's average velocity is indicated at 618.

Focusing on the vertical velocity components, at the first position 620, the jogger begins to push off his right foot and acquires an upward velocity of v₁ᵥ 604. As the jogger continues to push off his right foot in the second position 622, his vertical velocity grows to v₂ᵥ 608, as indicated by the longer vector. In the third position 624, the jogger has passed the apex of his trajectory. As his left foot hits the ground, the jogger has a downward velocity of v₃ᵥ 612, and in the fourth position 626, the downward velocity is arrested somewhat to measure v₄ᵥ 616. This pattern of alternately moving up and down in the vertical direction while the average velocity 618 is directed forward is indicative of a person jogging. When the jogger holds the device 102 in his hand, the device 102 measures time-dependent velocity components that also reflect the jogger pumping his arms back and forth. This velocity pattern is unique to jogging. If the jogger were instead biking with the same average speed, the vertically oscillating time-dependent velocity pattern would be exchanged for another. The time-dependent velocity components thus represent a type of motion “fingerprint” that serves to identify a particular transportation mode.

For an embodiment, the device 102 determining the motion profile 402 includes it determining time-dependent velocity components, that differ from the time-averaged velocity, and using the time-dependent velocity components to determine the transportation mode. When an average velocity indication of 10 mph is insufficient for the device 102 to definitively determine a transportation mode because it falls with the range of average speeds for both running and biking, for example, the device 102 considers additional information. For an embodiment, this additional information includes the time-dependent velocity components. In a further embodiment, the device 102 distinguishes between an automobile, a boat, a train, and a motorcycle as a transportation mode based on analyzing time-dependent velocity components.

FIG. 7 shows a diagram 700 of a user running with the device 102 in accordance with some embodiments of the present teachings. Specifically, FIG. 7 shows four snapshots 726-732 of the runner taken over an interval of time in which the runner makes two strides. The runner is shown taking longer strides, as compared to the jogger in diagram 600, and landing on his heels rather than the balls of his feet. Measured velocity components in the horizontal (v₁ₕ 702, v₂ₕ 706, v₃ₕ 710, v₄ₕ 714) and vertical (v₁ᵥ 704, v₂ᵥ 708, v₃ᵥ 712, and v₄ᵥ 716) directions allow the device 102 to determine that its user is running, and the average velocity, shown at 718, indicates how fast he is running. The device 102 having the ability to distinguish between running and jogging is important because running is associated with a higher level of stress that can more dramatically affect the speech signal in the acoustic signal.

For some embodiments, the device 102 determining the noise profile 406 includes the device 102 detecting at least one of user stress or noise level, and wherein modifying the speech signal includes modifying at least one of rate of speech, pitch, or frequency of the speech signal based on at least one of the user stress or the noise level. From collected data compiled in the motion profile 402, the device 102 is aware that the user is running and of the speed at which he is running. This activity translates to a quantifiable level of stress that has a given affect upon the user's speech and can also result in increased levels of noise. For example, the speech may be accompanied by heavy breathing, be varying in rate (such as quick utterances between breaths), be frequency shifted up, and/or be unevenly pitched. Historical records of the environmental conditions that the device 102 is subjected to and the stress affects on the user's voice can help determine which modifications to voice recognition processing to use in the future when the device 102 (and its user) is subjected to a like environment and conditions. Records such as these can remain resident on the device 102 in non-volatile storage 210 or can be stored on a remote server and updated or accessed via transceivers 218, 220.

In a particular embodiment, the device 102 modifying the speech signal further includes phoneme correction based on adaptive training of the device 102 to the user stress or the noise level. For this embodiment, programming within the voice recognition module 206 gives the device 102 the ability to learn a user's speech and the associated level of noise during periods of stress or physical exertion. While the speech-recognition software is running in a training mode, the user runs, or exerts himself as he otherwise would, while speaking prearranged phrases and passages into a microphone of the device 102. In this way, the voice recognition module 206 tunes itself to how the user's phonemes and utterances change while exercising. When the user is again engaged in the stressful activity, as indicated by the motion environment profile 408, the voice recognition module 206 switches to the correct database or file that allows the device 102 to interpret the stressed speech for which it was previously trained. This method provides improved voice-recognition accuracy during times of exercise or physical exertion. Alternatively, the device 102 can train such a mode on the user's natural speech in a state where the device 102 determines that speech is present via the VAD 208.

In an embodiment where determining a motion profile 402 includes determining a transportation mode, the device 102 adapting voice recognition processing includes the device 102 removing at least a portion of percussive noise, resulting from the transportation mode, from the acoustic signal. The percussive noise results from footfalls when the transportation mode includes traveling by foot or the percussive noise results from road irregularities when the transportation mode includes traveling by motor vehicle. The first type of percussive event is shown at 720. As the runner's left heel strikes the ground, there is a jarring that causes a shock and imparts rapid acceleration to the membrane of the microphone used to capture speech. The percussive event can also momentarily affect the speech itself as air is pushed from the lungs. The second percussive event is shown at 722 as the runner's right heel strikes the ground. When the runner is running at a constant rate, the heel strikes are periodic and occur at regular intervals. The percussive interval for the runner is shown at 724. When the percussive events are uniformly periodic, the device 102 can anticipate the times they will occur and use compression, suppression, or removal when performing noise reduction.

A second type of percussive event occurs randomly and cannot be anticipated. This occurs, for example, as potholes are encountered while the transportation mode is vehicular travel. The time at which this type of percussive event occurs is identified by the impulse imparted to one or more accelerometers of the device 102. The device 102 can then use compression, suppression, or removal when performing noise reduction on the acoustic signal by applying the noise reduction at the time index indicated by the one or more accelerometers.

In some embodiments, the device 102 can differentiate between percussive noise that originates at the device 102 (such as an impact with the device 102) and acoustic noise that originates away from the device 102 by using microphones that are located on opposite sides of the device 102 (e.g., a microphone on the front and back side of a smartphone). If the device 102 is brought down forcibly against a tabletop while face up, for example, the membranes of both microphones will continue to move in the downward direction immediately after the device 102 is stopped by the tabletop because of the inertia of the membranes. Upon impact of the device 102 with the tabletop, the shock imparted to the membranes of the microphones causes their motion to be in the same direction, but the electrical signals generated by the microphones are 180 degrees out of phase. While both membranes continue to move toward the table, due to one microphone facing forward and one facing rearward, the membrane of the back-side microphone moves out relative to its microphone structure while the membrane of the front-side microphone moves in relative to its microphone structure.

When an acoustic noise originates away from the device 102, the initial motion of the microphone membranes is caused by the resulting pressure wave reaching the microphones. If the frequency of the noise is below a few kilohertz, then the distance between the microphones is small compared to the wavelength of the noise. Therefore, the same part of the waveform (i.e., the same pressure) will reach each microphone at the same time, and the membranes of the microphones will move in phase with one another. In other words, the membranes of both microphones move inward with an increase in pressure and move outward with a decrease in pressure resulting in signals generated by the microphones that are in phase with one another. The ability to differentiate impacts with the device 102 from external acoustic noise allows the device 102 to apply the correct form of noise reduction. External acoustic noise, for example, might be acoustically isolated and removed, whereas compression or cancellation (e.g., summing the phase inverted signals) might be used to reduce impact noise.

For an embodiment where the motion profile 402 includes determining a time-averaged velocity for the device 102 based on a set of time-dependent velocity components for the device 102, the device 102 modifying the speech signal includes the device 102 modifying at least one of an amplitude or frequency of the speech signal based on at least one of the time-averaged velocity or the time-dependent velocity components. The device 102 applies this type of signal modification when it experiences periodic motion relative to a user's mouth.

As shown at FIGS. 8A and 8B, is a user running with the device 102. That the user is running is determined from the average speed and time-dependent velocity components for the device 102, and indicated in the motion environment profile 408. At 810, the runner has the device 102 strapped to her right upper arm, whereas at 812, she is holding the device 102 in her left hand. As her hand and arm pump forward and back while she is running, the position and velocity of the device 102 relative to her mouth change as she is speaking. This relative motion affects the amplitude and frequency of the speech. As shown at 810, the distance 802 is at its greatest when the runner's right arm is fully behind her. In this position, her mouth is farthest away from the device 102 so that the amplitude of captured speech will be at a minimum. While she moves her right arm forward, the velocity 804 of the device 102 is toward her mouth, and the frequency of her speech will be Doppler shifted up as the distance closes.

At 812, the device 102 is at a distance 806 that is relatively close to the runner's mouth, so the amplitude of her speech received at the microphone will be higher. The velocity 808 of the device 102 is directed away from her mouth so as her speech is received, it will be Doppler shifted down. Having knowledge of the velocity or acceleration of the device 102 allows for modification of the acoustic signal to account for the repetitive motion of the device 102. Motion-based speech effects, such as modulation effects, can be overcome by adapting the gain of the signal based on the time-dependent velocity vectors captured by the motion sensors 204. Additionally, the Doppler shifting caused by periodic or repetitive motion can be overcome as well.

For a particular embodiment, the device 102 improves the speech signal by modifying it in several ways. The device 102 modifies the frequency of the speech signal to adjust for Doppler shift, modifies the amplitude of the speech signal to adjust for a changing distance between the device's microphone and a user's mouth, modifies the rate of speech in the speech signal to adjust for a stressed user speaking quickly, and/or modifies the pitch of the speech signal to adjust for a stressed user speaking at higher pitch. In a further embodiment, the device 102 makes continuous, time-dependent modifications to correct for varying amounts of frequency shift, amplitude change, rate increase, and pitch drift in the speech signal. These modifications increase the accuracy of voice recognition over a variety of activities in which the user might engage.

FIG. 9 shows a schematic diagram 900 illustrating the determination of a temperature profile for the device 102 in accordance with some embodiments of the present teachings. Indicated on the diagram at 902, is a temperature measured at the device 102 (also referred to herein as a first temperature reading) of 71 degrees. In an embodiment, this temperature is taken using the thermocouple 106. Indicated at 904, is a reported temperature (also referred to herein as a location-based temperature reading or a second temperature reading) from a second device external to the device 102 of 87 degrees. The reported temperature can be a forecasted temperature or a temperature taken at a weather station for an area in which the device 102 is located, based on its location information. The location-based temperature reading therefore represents an outdoor temperature at the location of the device 102. A threshold band centered at the reported temperature appears at 906.

For a particular embodiment, the device 102 determining a temperature profile includes the device 102: determining a first temperature reading using a temperature sensor internal to the device 102; determining a temperature difference between the first and second temperature readings; and determining a temperature indication of whether the device 102 is indoors or outdoors based on the temperature difference, wherein the motion environment profile 408 is determined based on the temperature indication. In the embodiment shown at 900, the temperature indication is set to indoors because the difference between the reported (second) temperate and the device-measured (first) temperature is greater than a threshold value of half the threshold band 906. In an embodiment where the first temperature is measured to be 85 degrees, the temperature indication is set to outdoors because the first temperature falls within the threshold band 906. In this case, the two-degree discrepancy between the first and second temperature readings is attributed to measurement inaccuracies and temperature variances over the area in which the device 102 is located.

In an embodiment for which the location-based temperature is 71 degrees, the method depicted at 900 for determining a temperature indication is indeterminate. If the outside temperature is the same as the indoor temperature, a temperature reading at the device 102 provides no useful information in determining if the device 102 is indoors or outdoors. For a particular embodiment, the width of the threshold band is a function of the reported temperature. When the outdoor temperature (e.g., 23° F.) is very different from a range of common indoor temperatures (e.g., 65-75° F.), less accuracy is needed, and the threshold band 906 may be wider. As the reported outdoor temperature becomes closer to a range of indoor temperatures, the threshold band becomes more narrow.

Using a method analogous to that depicted at 900, a noise indication is set to indicate if the device 102 is indoors or outdoors. FIG. 10 shows a diagram 1000 illustrating a method for determining the noise indication based on a wind profile and a measured speed for the device 102. Shown in the diagram 1000 is a wind profile indicating a wind speed of 3 mph, at 1004. At 1002, a GPS receiver for the device 102 indicates the device 102 is moving with a speed of 47 mph. A threshold band, centered at the GPS speed 1002, is shown at 1006.

In an embodiment where determining the motion profile 402 includes determining the device speed, the device 102 determining the noise profile 406 includes the device 102: detecting wind noise; analyzing the wind noise to determine a wind speed; and setting a noise indication based on a calculated difference between the device speed and the wind speed. In the embodiment shown at 1000, the device 102 takes an ambient noise sample (from the acoustic signal using the VAD 208, for example) and compares a wind-noise profile taken from it to stored spectra and amplitude levels for known wind speeds. Analyzing the sample in this way, the device 102 determines that the wind profile matches that of a 3 mph wind. The GPS receiver, however, indicates the device 102 is traveling at 47 mph. Based on the large difference between the device speed and the wind speed, the device 102 determines that it is in an indoor environment (e.g., traveling in an automobile with the windows rolled up) and sets the noise indication to indicate an indoor environment.

For the embodiment shown, any wind speed that falls below the threshold band 1006 is taken to indicate the device 102 is in an indoor environment, and the noise indication is set to reflect this. In an embodiment where the wind speed is determined to be 46 mph from comparisons with stored wind speed profiles, the device 102 sets the noise indication to indicate an outdoor environment because the wind speed falls within the threshold band 1006 centered at 47 mph. For a particular embodiment, the width of threshold band 1006 is a function of the speed indicated for the device 102 by the GPS receiver or other speed-measuring sensor.

For one embodiment, the device 102 sets the noise indication to indicate that the device 102 is indoors or outdoors based on a difference between the device speed and the wind speed. Particularly, when the difference between the device speed and the wind speed is greater than a threshold speed, the device 102 selects, based on the indoors noise indication, multiple microphones to receive the acoustic signal. Whereas, when the difference between the device speed and the wind speed is less than the threshold speed, the device 102 selects, based on the outdoors noise indication, a single microphone to receive the acoustic signal. For this embodiment, the threshold speed is represented in the diagram 1000 by half the width of the threshold band 1006. The embodiment also serves as an example of when adapting the voice recognition module 206 includes changing a microphone, or changing a number of microphones, used to receive the acoustic signal. Multiple-microphone algorithms offer better performance indoors, whereas single-microphone algorithms are a better choice for outdoor use when wind is present because a single-microphone is better able to mitigate wind noise. Additionally if wind is detected at an individual microphone, that microphone can be deactivated and other microphones in the device used.

FIG. 11 is a logical flowchart of a method 1100 for determining the stationarity of noise to perform noise reduction in accordance with some embodiments of the present teachings. In several embodiments, the device 102 determining a type of noise includes the device 102 determining whether noise in the acoustic signal is stationary or non-stationary. As used herein, the stationarity of noise is an indication of its time independence. Tire noise from an automobile driving on smooth and uniformly paved roadway is an example of stationary noise. Wind noise is another example of stationary noise. Conversely, the ambient noise at a crowded venue, such as a sporting event, is an example of non-stationary noise. The noise spectrum at a football game, for instance, is continuously changing due to random sounds and background chatter.

The frequency spectrum and peak-to-average characteristics for stationary noise remains relatively constant in time (as compared to the frequency spectrum and peak-to-average characteristics for non-stationary noise). Therefore, the device 102 can determine the stationarity of noise based on the frequency spectrum for the noise. In other embodiments, the device 102 determines the stationarity of noise based on temporal information for the noise.

The energy of stationary noise is constant in time, whereas the energy of non-stationary noise has a time dependence. This allows the device 102 to determine the stationary of noise based on time averages of energy for the noise on different time intervals. In an embodiment, the device 102 compares the average energies on different time intervals to determine the stationarity of the noise. The device 102 integrates the energy of the noise over a first time interval and divides the result by the duration of the first time interval to determine a first average energy for the first time interval. Similarly, the device 102 determines a second average energy for a second time interval that is different than the first time interval. The different time intervals used to determine the average energies may have the same duration, have different durations, be overlapping, and/or be non-overlapping. The device then compares the average energies for the different time intervals to determine the stationary of the noise.

For some embodiments, the device 102 compares a set of two or more average energies for different time durations by determining a variance for the set of average energies (or some other statistic that quantifies the spread of the average energies). In an embodiment where a stationarity of noise is treated as a continuous random variable capable of taking on a theoretically infinite number of values (in reality, a large number of discrete values that depend on the precision of a measuring apparatus), a lower variance indicates a more stationary noise, and a higher variance indicates a less stationary (or more non-stationary) noise. In embodiments where a stationarity of noise is treated as a discrete random variable, the stationarity of the noise is determined from one or more threshold variance values. For example, in an embodiment where a stationarity of noise is treated as a binary determination, a variance that falls below a single threshold variance value indicates a stationary noise, and a variance that falls above the single threshold variance value indicates a non-stationary noise. Additional threshold variance values define additional levels of stationarity. Two threshold values, for instance, allows a noise to be classified as a low-stationary noise, a medium-stationary noise, or a high-stationary noise, depending on where the variance determined for a set of average energies falls relative to the two threshold values.

In other embodiments, the device 102 determines a stationary of noise based on temporal information using specific spectral ranges. For example, the device determines a set of average energies for the noise only within a spectral band that corresponds to the frequency range of the human voice. In further embodiments, the device 102 determines a stationary of noise based on both spectral and temporal information for the noise. For example, the device 102 can determine how a specific spectral component of the noise varies over time, or the device 102 can combine separate assessments of stationary made independently using spectral and temporal methods to make a final determination for the stationarity of the noise.

For the method 1100, the device 102 receives 1102 an acoustic signal, analyzes 1104 the noise in the signal, and makes 1106 a determination of whether the noise is stationary or non-stationary. For some embodiments, the device 102 further performs noise reduction and voice recognition on the acoustic signal, wherein the device uses 1110 single-microphone stationary noise reduction when the noise is determined to be stationary and uses 1108 multiple-microphone non-stationary noise reduction when the noise is determined to be non-stationary.

In additional embodiments, one or more trigger parameters related to voice recognition processing are adjusted based on the stationarity of the noise. For one embodiment, the one or more trigger parameters include a trigger threshold. For another embodiment, the one or more trigger parameters include a trigger delay. The term “trigger,” as used herein, refers to an event or condition that causes or precipitates another event, whereas the term “trigger threshold” refers to a sensitivity or responsiveness of the trigger to that event or condition. In the present disclosure, the events relate to voice recognition processing. A trigger threshold is an example of a trigger parameter. Trigger parameters are properties or features of a trigger than can bet set and adjusted to affect the operation of the trigger, which, in turn, affects voice recognition processing. A trigger delay is a further example of a trigger parameter. A trigger delay, as used herein, refers to a time interval by which the application of a trigger to an acoustic signal or a speech signal is postponed or deferred. Turning momentarily to FIGS. 12 and 13, triggers and trigger parameters related to voice recognition processing are described in greater detail.

Illustrated in FIG. 12 at 1200 are three triggers 1204-1208 and their sequential relationship to one another for an embodiment in which they are applied to an acoustic signal 1202 that includes a speech signal. For a particular embodiment, the voice recognition module 206, the VAD 208, the signal processing module 216, and/or the processing element 214 performs the processing associated with applying the triggers 1204-1208 to the acoustic signal 1202. After receiving the acoustic signal 1202, a device, such as device 102, applies the trigger for phoneme detection 1204 to the acoustic signal 1202. The trigger for phoneme detection 1204 allows the device 102 to detect speech. The device 102 uses phonemes as an indicator for the presence of speech because phonemes are the smallest contrastive unit of a language's phonology. They are the basic sounds a speaker makes while speaking.

For some embodiments, phoneme detection is performed by the VAD 208, which in a particular embodiment is colocated with the voice recognition module 206. The VAD 208 can, for example, apply one or more statistical classification rules to a section of the acoustic signal to determine the presence of a speech signal for that section. For an embodiment, potential phonemes isolated from the acoustic signal are compared to spectral patterns for phonemes stored in a library database. This database, and any other databases used by the device 102 in connection with speech recognition, can be stored locally, such as in non-volatile storage 210, or stored remotely and accessed using the transceivers 218, 220. As indicated at 1204, the device 102 uses the phoneme detection trigger to differentiate between a person speaking and other sounds. When the phoneme detection trigger 1204 is “tripped,” the device 102 operates under the supposition that a person is speaking. The point at which, or the minimum condition under which, the phoneme detection trigger 1204 is tripped, indicating a positive outcome (in this case, that a person is speaking) is determined by a trigger threshold for phoneme detection.

When a person is speaking, the device 102 attempts to match phonemes in the speech signal to phrases, as indicated at 1206 by the phrase matching trigger. As used herein, a phrase is a recognizable word, group or words, or utterance that has operational significance. Phrases relate to or affect the operation of the device 102. A command, for example, is a phrase: a word or group of words that are recognized by the device 102 and affect a change in its operation. The phrase “call home,” for instance, causes a device with phone capabilities to dial a user's place of residence. A command may also be given by uttering a phrase that does not have a dictionary definition but which causes a preprogrammed device to take a specific action. In a further example, phrases are words spoken by a user reciting a text message. As the device 102 recognizes the words, it constructs the message before sending it to an intended recipient.

In embodiments relating to command recognition, the trigger condition for phrase matching is a match between phonemes received and identified in the speech signal to phonemes stored as reference data for a programmed command. When a match occurs, the device 102 performs the command represented by the phonemes. What constitutes a match is determined by a trigger threshold for phrase matching. For an embodiment, a match occurs when a statistical confidence score calculated for received phonemes exceeds a value set as the trigger threshold for phrase matching. The trigger's threshold or sensitivity is the minimum degree to which a spoken phrase must match a programmed command before the command is performed. Words not programmed as a command, that may instead be part of a casual conversation, are ignored, as indicated at 1206.

In embodiments relating to text messaging, words are not ignored. The phrase matching trigger 1206 is tripped upon recognizing any word in the speech signal, and the device 102 incorporates the words into the speaker's text message in the order in which they are recited. For a particular embodiment, an individual word is discarded or dropped from the message after tripping the phrase matching trigger 1206 if the words fails to make contextual or grammatical sense within the message, such as in the case of a repeated word. In another embodiment, the device 102 drops or discards phrases if it cannot verify the phrases were spoken by a person authorized to use the device 102.

It is the speaker verification trigger, indicated at 1208, that allows the device 102 to determine (within a confidence interval) whether phrases detected in a speech signal were uttered by an authorized user. For an embodiment, the device 102 imposes the speaker verification trigger 1208 after the trigger threshold for phrase matching is met. After the device 102 determines that a command was spoken, for example, the phonemes representing the command are applied against the speaker verification trigger 1208 to determine if the speaker of the command is authorized to access the device 102.

For an embodiment, speaker verification is accomplished by training the device 102 for an authorized user. The user trains the device 102 by speaking commands into the device 102, and the device 102 creates and stores (either locally or remotely) a speech profile for the user. When the device 102 detects a command outside of the training environment for the device 102, the device 102 compares the received phonemes for the command against the speech profile stored for the authorized user. The device 102 calculates a score based upon a comparison of the captured speech to the stored speech profile to determine a level of confidence that the command was spoken by the authorized user. A score or level of confidence that exceeds the trigger threshold for speaker verification will cause the device to accept and execute the received command. In additional embodiments, the device 102 creates and stores multiple speech profiles for one or more authorized users.

FIG. 13 contrasts two trigger delays for a trigger related to voice recognition processing, taken here to be the phrase matching trigger 1206. More specifically, FIG. 13 shows how the trigger delay is adjusted based on the noise level. Indicated at 1300 is an acoustic signal having a low noise level 1306 that includes a speech signal 1304. The speech signal 1304 represents a single word that has a duration of about 15% of the acoustic signal shown. The speech signal is bordered on both sides by the low level noise 1306. Upon receiving the speech signal 1304, as detected by the VAD 208 and/or the phoneme detection trigger 1204, for example, the device initializes a timer to time a first trigger delay, shown at 1308. This interval begins as the word 1304 is received, and for an embodiment, continues for a duration that is based on the noise level.

The portion of the acoustic signal associated with the first trigger delay, and the phonemes therein, are not applied to the phrase matching trigger 1206 until the end of the first trigger delay interval. The purpose of the trigger delay is to determine whether additional speech follows the received word 1304. Some commands programmed into the device 102, such as “call home” or “read mail,” for instance, are two-word commands. In this way, an entire double- or multi-word command is applied against the phrase matching trigger for detection. If no additional words are received in the first delay time, as shown, the noise after the word 1304 that falls within the first trigger delay interval becomes part of the confidence score for phoneme matching. The noise included in the delay interval will lower the overall score, but only by a limited amount because the noise level is low.

Indicated at 1302 is an acoustic signal having a high noise level 1312, relative to the noise level 1306, that includes a speech signal 1310 representing the same word spoken at 1304. Here, the device 102 applies a second trigger delay 1314, which is less (shorter) than the first trigger delay 1308. Because the noise level is higher at 1312, a calculated confidence score for phrase matching would be lower if the second trigger delay 1314 was the same duration as the first trigger delay 1308. This is especially true if the noise 1312 is dynamic, such as for non-stationary noise. In situations where a second word is not received, the drop in score might be enough such that the trigger threshold for phrase matching is no longer met for the single word spoken at 1310. Therefore, in the presence of higher noise levels, the device 102 lowers the trigger delay such that it is still able to wait a reasonable amount of time for a second word without ruining a score for the first word 1310 should a second word not be received.

In alternate embodiments, the device 102 applies a second trigger delay 1314 in the presence of a high noise level 1312 that is longer (not shown) than the first trigger delay 1308 in the presence of a low noise level 1306. For a particular embodiment, the device 102 captures a portion of an acoustic signal that includes a speech signal followed by noise of a duration determined by a trigger delay. The device 102 used the VAD 208 to truncate the captured portion of the acoustic signal to remove the noise following the speech signal before processing the truncated acoustic signal for voice recognition. In a low noise environment, the VAD 208 can detect the beginning of a second word in the captured portion of the acoustic signal with greater certainty than for a high noise environment. In the high noise environment, the beginning of the second word is obscured to a greater degree by the noise. By setting a longer trigger delay for the high noise environment, more of the second word is captured. With more of the second word captured, the VAD 208 is more likely to detect the second word and less likely to truncate and discard it as noise.

In some instances, the device 102 uses a VAD external to the device, such as a cloud-based VAD for which algorithms are more up to date, to detect speech signals in the captured portion of the acoustic signal prior to truncation. By setting a longer trigger delay during noisy conditions, it is less likely that a second voice signal in the captured portion of the acoustic signal will get lost. Because the captured portion of the acoustic signal is truncated before voice recognition processing, the longer trigger delay in the presence of greater noise does not adversely affect confidence scores calculated for the captured signal.

Returning to FIG. 11, the trigger thresholds for phoneme detection, phrase matching, and speaker verification are shown to be adjusted downward (decreased), at 1112, 1116, and 1120, respectively, when the device 102 determines 1106 noise in the acoustic signal is non-stationary. Conversely, when the device 102 determines 1106 the noise is stationary, it increases the trigger thresholds for phoneme detection, phrase matching, and speaker verification, as shown at 1114, 1118, and 1122, respectively. In additional embodiments, the device 102 decreases trigger delays associated with the indicated triggers at 1112, 1116, and 1120, when the device 102 determines 1106 the noise is non-stationary, and the device 102 increases trigger delays associated with the indicated triggers at 1114, 1118, and 1122, when the device 102 determines 1106 the noise is stationary.

In a noisy environment where the noise is non-stationary, the noise obscures characteristics of the received phonemes and reduces the degree to which those phonemes “match” the phonemes stored in an authorized user's speech profile. This results in a lower score, and thus lowers the device's confidence that speech was received and also that it was received from an authorized user, even when an authorized user is speaking. For this reason, a trigger threshold for voice recognition and/or speaker verification is adjusted downward in the presence of non-stationary noise and/or increasing levels of noise. Non-stationary noise obscures the characteristics of the received phonemes more so than for stationary noise.

Additionally, in a noisy environment where the noise is non-stationary, trigger delays are set low. The device 102 waits less time to receive additional speech before applying a trigger to a portion of the acoustic signal, associated with that trigger's delay, to calculate a confidence score for the portion of the acoustic signal. Waiting a shorter time before applying the trigger allows the non-stationary noise to have a lower cumulative affect upon the confidence score calculated for the trigger's application. In a noisy environment, as user might train himself to speak multi-word commands more quickly, or without hesitation, to accommodate the device 102 adjusting trigger delays. For stationary noise, which has less impact on a confidence score, the device 102 can extend the trigger delay. For an alternate embodiment, the trigger delay is set higher for non-stationary noise to capture more of a second utterance and increase the probability that the second utterance is detected by the VAD 208 and not truncated as noise. Embodiments for which the device 102 adjusts one or more trigger parameters based on a noise type are described in greater detail with reference to FIGS. 16-19.

In alternate embodiments (not shown), the device 102 may adjust the trigger thresholds for phoneme detection, phrase matching, and speaker verification upward, at 1112, 1116, and 1120, respectively, when the device 102 determines 1106 noise in the acoustic signal is non-stationary. For these alternate embodiments, the device 102 adjusts the trigger thresholds for phoneme detection, phrase matching, and speaker verification downward, at 1114, 1118, and 1122, respectively, when the device 102 determines 1106 noise in the acoustic signal is stationary.

In a noisy environment where the noise is non-stationary, trigger thresholds related to voice recognition are set high (i.e., increased) to prevent false positives. Such false positives can be caused by other voices or random sound occurrences in the noise. In a non-stationary noise condition, for example, there may be many people talking. The chances of detecting phonemes triggering speaker verification are higher when additional speech from unauthorized individuals is included in the noise. In such a case, the trigger threshold for speaker verification is set high so that the device 102 is not triggered by the voice of an unauthorized person.

When the device 102 determines 1106 that the noise is stationary, it lowers the trigger thresholds related to voice recognition, making the triggers less discriminating (using lower tolerances to “open up” the triggers so they are more easily tripped). This is because a false positive is less likely to be received from stationary noise. In a stationary noise condition, for example, the trigger threshold for phrase matching is reduced, thereby reducing the likelihood that a valid command spoken by an authorized user fails to be detected because the command was not articulated clearly. These alternate embodiments are described in greater detail with reference to FIGS. 20 and 21.

For FIG. 11, when the device 102 determines 1106 noise in the acoustic signal is non-stationary, each of the actions 1108, 1112, 1116, and 1120 can be performed optionally in place of or in addition to the others. Similarly, when the device 102 determines 1106 noise in the acoustic signal is stationary, each of the actions 1110, 1114, 1118, and 1122 can be performed optionally in place of or in addition to the others. Therefore, each of the eight actions 1108-1122 is shown in FIG. 11 as an optional action.

In addition to adjusting trigger parameters related to voice recognition based on the stationary of noise, the trigger parameters can also be adjusted based on other characteristics of noise. For one embodiment, a trigger threshold is adjusted based on the level of noise. Embodiments that reflect this additional or alternate dependence of trigger parameters on noise characteristics are described with reference to the remaining FIGS. 14-21. FIG. 14 describes a method 1400 for adjusting trigger parameters related to voice recognition based on the determination of a noise profile for the acoustic signal. For the embodiment shown, the method 1400 begins with the device 102 receiving 1402 an acoustic signal that includes a speech signal. From the acoustic signal, the device 102 determines 1404 a noise profile, such as the noise profile indicated in FIG. 4 at 406. For an embodiment, the noise profile 406 identifies a noise level of noise in the acoustic signal in addition to a noise type. For an embodiment, the device 102 determines a noise type by analyzing a frequency spectrum for the noise. Type categories for noise include, but are not limited to, stationary noise, non-stationary noise, intermittent noise, and percussive noise. Intermittent noise, for example, is discontinuous or occasionally occurring noise that is distinguishable from the background noise of the acoustic signal. The presence of different types of noise may affect how voice recognition processing is performed.

In an example, the device 102 analyzes a frequency spectrum of noise to determine that the noise is low-frequency noise of a specific type. The low-frequency noise may be associated with the running engine of an automobile, for instance. This type of noise has a higher energy level in the lower frequency range while having a comparatively lower energy level in the mid to upper frequency range where human speech occurs. Therefore, low-frequency automobile noise is not likely to adversely affect confidence scores associated with speech recognition processing to the same degree as noise that has a higher spectral energy level occurring at the same frequencies as human speech. Based on higher low-energy spectral characteristics, the device 102 increases trigger threshold levels and/or increases trigger delays when automobile engine noise is detected, for example. Conversely, the device 102 decreases trigger threshold levels and/or decreases trigger delays when higher-pitched engine noise is detected, such as engine noise from a chain saw or a model airplane. Noises that have higher spectral levels in the frequency range of human speech tend to reduce calculated confidence scores associated with triggers related to voice recognition processing. Therefore, trigger thresholds are reduced in the presence of such noise so the actual voice of an authorized user is not “screened out.” Multi-tonal noise, such as music, also has a greater ability to affect voice recognition processing than many types of low-frequency noise. In each case, the device 102 adjusts the trigger parameters to perform voice recognition processing more effectively.

For one embodiment, the noise profile 406 includes a measure of the stationary of noise in the acoustic signal. For another embodiment, the noise profile 406 identifies a level of noise in the acoustic signal. As used herein, the level of noise can refer to either an absolute or relative measurement of noise in the acoustic signal. The level of noise can be the absolute sound pressure level (SPL) of the noise as measured in units of pressure (e.g., pascals). The level of noise can also be measured as a power level or intensity of the noise and expressed in units of decibels. Further, the level of noise can refer to a ratio of the pressure or intensity of the noise in the acoustic signal to the pressure or intensity of speech in the acoustic signal.

The device 102 can optionally determine 1406 a motion profile for itself, such as the motion profile indicated in FIG. 4 at 402. Depending on the optional determination of a motion profile 402, the device 102 performing method 1400 takes different actions. If a motion profile 402 was determined 1408, the device 102 determines 1412 a motion environment profile, such as the motion environment profile indicated in FIG. 4 at 408, from the noise profile 406 and the motion profile 402. The device 102 goes on to adjust at least one trigger parameter related to voice recognition based on the motion environment profile 408. If a motion profile 402 was not determined 1408, the device 102 adjusts the at least one trigger parameter based on the noise profile 406 alone.

In one embodiment, the device 102 adjusts 1410 a trigger parameter based on the noise profile 406 by adjusting a trigger threshold as a continuous function of the noise level or a step function of the noise level. In another embodiment, the device 102 adjusts 1410 a trigger parameter by adjusting a trigger delay based on the stationarity of the noise, which is indicated in the noise profile 406 for the device 102 as the noise type. For example, the device adjusts the trigger delay based on a decreasing function of the non-stationarity of the noise.

Turning momentarily to FIGS. 16-21, different functional dependencies of trigger parameters on noise characteristic are shown at 1600, 1700, 1800, 1900, 2000 and 2100, which are described in detail. Shown on the horizontal axis (i.e., abscissa) of graphs 1600, 1700, 1800, 1900, 2000 and 2100, at 1602, 1702, 1802, 1902, 2002 and 2102, respectively, is the measured value of a noise characteristic, which represents the independent variable. The noise characteristic is shown as either a level of noise or a stationarity of noise. With increasing horizontal distance from the origin (toward the right), the level and non-stationarity of noise increases.

The setting or value of a trigger parameter is the dependent variable shown on the vertical axis (i.e., ordinate) of graphs 1600, 1700, 1800, 1900, 2000 and 2100. For graphs 1600, 1700, 2000 and 2100, the trigger parameter is a trigger threshold, whereas for graphs 1800 and 1900, the trigger parameter is a trigger delay. With increasing vertical distance from the origin (upward), the trigger threshold level of graphs 1600, 1700, 2000 and 2100 increases, making the trigger more discriminating. In graphs 1800 and 1900, increasing vertical distance corresponds to an increase in trigger delay.

The line 1606 of the graph 1600 represents a continuous functional dependence of the trigger threshold level 1604 on the noise characteristic 1602. A continuous functional dependence, as used herein, indicates that there are no breaks or gaps in a function over the operational range of its domain—stated mathematically,

$${lim}_{x \to c} f ( x ) = f ( c ) .$$

The operating range of the domain, in turn, refers to the range of the noise characteristic 1602 within which the device 102 is configured to operate. In a particular embodiment, the continuous function is also smooth, or everywhere differentiable, over the operating range of the domain.

While a linear function is shown at 1606, linearity is not imposed herein as a condition of continuous functional dependence. In other embodiments, continuous functional dependence of the trigger threshold level upon the noise characteristic may be represented by, but is not limited to: power functions, exponential functions, logarithmic functions, and trigonometric functions. In further embodiments, continuous functions can be constructed from different types of functions such that there are different functional dependencies on different portions of the domain. In a first example, line segments with different slopes are joined across the operational range of the domain. In a second example, a line segment is joined with a function that has a fractional-power dependence on the noise characteristic. For a further embodiment (not shown) a trigger parameter is a function of multiple noise characteristics. Where the functional dependence is upon two different noise characteristics, for example, the values assumed by the trigger parameter define a surface.

FIG. 17 shows the functional dependence of the trigger threshold level 1704 on the noise characteristic 1702 as a step function 1706. The step function 1706 shown is a three-value step function with three defined levels or tiers. The separation of the levels occur at the transition points 1708, 1710. When the value of the noise characteristic falls below the first transition point 1708, the trigger threshold level is set to the value represented by the first (uppermost) level of the step function 1706. When the value of the noise characteristic falls between the first transition point 1708 and the second transition point 1710, the trigger threshold level is set to the value represented by the second (middle) level of the step function 1706. When the value of the noise characteristic raises above the second transition point 1710, the trigger threshold level is set to the value represented by the third (lowermost) level of the step function 1706. In different embodiments, the functional dependence of the trigger threshold level 1704 on the noise characteristic 1702 will be represented by different step functions. Those step functions will have different numbers of levels (and thus transition points), different or uniform spacing between levels, and/or different or uniform spacing between transition points.

Focusing momentarily on the noise level as being the noise characteristic, the noise level will affect a statistical confidence score calculated for a trigger as indicated with reference to FIG. 12. That is, increased levels of noise will reduce the confidence score calculated for the application of a trigger to a portion of an acoustical signal. For a specific embodiment, a confidence score calculated for the application of the phrase matching trigger 1206 depends on the occurrence of phonemes in two ways. First, the device 102 bases the confidence score on the phonemes identified in the speech signal. Second, the device 102 further bases the confidence score on the order of the phonemes identified in the speech signal. For example, the device may identify three received phonemes in a portion of the acoustic signal as phonemes 16, 27, and 38 (no order implied). If the specific order 27-16-38 of those phonemes corresponds to a command, than that order will result in a higher confidence score as compared to receiving the phonemes in a different order, unless the different order also corresponds to a command.

In another embodiment, the device 102 identifies a number of phonemes that match a particular command from a number of phonemes it receives to calculate a confidence score for that command. The device 102 being able to match 7 received phonemes to a command that has 10 phonemes will result in a higher confidence score for that command than if the device 102 was only able to match 5 received phonemes to the command. If the confidence score for the command is above the trigger threshold for that command, then the device 102 accepts the command.

In the presence of a first level of noise, a trigger threshold for phrase matching is set such that a user speaking the command “call home” results in the phrase matching trigger 1206 being tripped. The device accepts the command and dials the user's home number. In this example, the confidence score calculated for the users command is taken to be 96. For the same (first) level of noise, confidence scores for phonemes received out of the noise, phonemes that are not received from an authorized user or not associated with a command, are distributed in a range with an upper limit of 78. The idea is to set the trigger threshold (which represents a particular confidence score) to a value between 78 and 96, such as 85, for example. Noise will score below the threshold (85) and be ignored, whereas the user's commands will score above the threshold (85) and trigger the device 102.

Continuing with the above example, the noise level increases from the first noise level to a second noise level. In the presence of the higher (second) noise level, the device's calculated confidence scores will drop (due to the noise) for the user's command “call home.” If the confidence score calculated for the users command drops from 96 to 82 in the presence of the second level of noise, the user's command will no longer trigger the device 102 where the trigger threshold is 85. At the same time, the upper limit on scores not associated with an actual command might drop from 78 down to 66 due to the higher noise level. The solution is to adjust the first trigger threshold from 85 down to a second trigger threshold, 75, for example, that lies between 66 and 82. As a result, in the presence of the higher (second) noise level, the device 102 is still triggered by the user's commands (75<82) but it continues to ignore noise and phonemes not associated with commands (66<75).

In different embodiments, the device can adjust a trigger threshold differently based on a changing noise level for different types of noise. For example, for both stationary and non-stationary types of noise, the device 102 adjusts the trigger threshold downward (lowers the trigger threshold) as the noise levels increase as described above. For a stationary type noise, however, the trigger threshold may be decreased less rapidly as compared to a non-stationary type noise. In an alternate embodiment, the trigger threshold is adjusted downward more rapidly with increasing levels of noise if the noise type is determined to be stationary rather than non-stationary.

Both graphs 1600 and 1700 represent embodiments where a trigger threshold is adjusted based a noise level or the stationary of the noise. An embodiment wherein the noise type comprises a stationarity of the noise, and the trigger threshold is adjusted based on a binary determination of the stationarity of the noise is represented by a two-valued step function replacing the three-valued step function shown at 1706. The higher of the two values is representative of stationary noise, whereas the lower value is representative of non-stationary noise.

FIG. 18 shows a graph 1800 that represents a continuous functional dependence of a trigger delay time 1804 on a noise characteristic 1802. Specifically, the graph 1800 represents a continuously decreasing function of the noise level or a non-stationarity of the noise. For an embodiment, the trigger delay 1804 is adjusted based on the decreasing function of the noise level such that a first trigger delay associated with a first noise level is greater than a second trigger delay associated with a second noise level when the second noise level is greater than the first noise level. In contrast to the graph 1600, graph 1800 provides a non-linear example of continuous functional dependence of a trigger parameter on a noise characteristic 1802. For another embodiment, the trigger delay is adjusted based on an increasing function (not shown) of the noise level such that a first trigger delay associated with a first noise level is less than a second trigger delay associated with a second noise level when the second noise level is greater than the first noise level.

FIG. 19 shows a graph 1900 that represents a non-continuous functional dependence of a trigger delay time 1904 on a noise characteristic 1902. specifically, the graph 1900 represents a decreasing step function of the noise level or a non-stationarity of the noise. For an embodiment, the trigger delay 1904 is adjusted based on a decreasing function of the non-stationarity of the noise such that a first trigger delay associated with a stationary noise is greater than a second trigger delay associated with a non-stationarity noise. In contrast to the graph 1700, graph 1900 provides an example of a two-value step function of a noise characteristic 1902, with a single transition point 1908, where the second (lower) value accounts for a larger portion of the operational range of the domain than the first (higher) value. For another embodiment, the trigger delay is adjusted based on increasing function (not shown) of the non-stationarity of the noise such that a first trigger delay associated with a stationary noise is less than a second trigger delay associated with a non-stationarity noise.

Returning to FIG. 14, focusing specifically on adjusting a trigger parameter at 1410 and 1414, for several embodiments, the device 102 adjusting the trigger parameter is based on a sequential determination of different noise characteristics. For a particular embodiment, when the noise is determined to be non-stationary, a trigger threshold or a trigger delay is adjusted based on a first function of the level of the noise. Alternatively, when the noise is determined to be stationary, the trigger threshold or the trigger delay is adjusted based on a second function of the level of the noise, wherein the first function is different than the second function. Two methods that reflect these types of embodiments are illustrated in FIG. 15 at 1500.

For one method shown at 1500, the device 102 begins by first determining 1504 the stationary of noise in the acoustic signal. Based on the determination, the device 102 takes different actions. In an embodiment, these actions are controlled by an algorithm executed by either the processing element 214, the voice recognition module 206, the VAD 208, and/or the signal processing module 216 within the device 102. If the noise is determined 1506 to be non-stationary, then the device 102 determines 1508 the level of the noise and adjusts 1512 the trigger parameter as a first function of the level of noise. If, alternatively, the noise is determined 1506 to be stationary, the device 102 also determines 1510 the level of the noise but instead adjusts 1514 the trigger parameter as a second function of the level of noise. For a specific embodiment, after the trigger parameter has been adjusted at 1512 or 1514, the device 102 again determines 1504 the stationary of the noise in the acoustic signal, and the process repeats. If the stationary of the noise changes during the process, then the function used by the device 102 to adjust the trigger parameter changes accordingly due to the determination made at 1506. For an embodiment, the stationarity of the noise changes when successive quantitative measurements of the stationarity fall on opposite sides of a threshold value set for the determination of the stationarity.

Another method shown at 1500 includes the use of an optional timer. The device 102 begins by initializing 1502 the timer and then continues with the actions 1504-1514 as described previously. After the device 102 adjusts the trigger threshold at 1512 or 1514, however, the device 102 queries the timer, at 1516 or 1518, respectively, to determine if more than a threshold amount of time has elapsed. If the threshold time is not exceeded, the device 102 again determines 1508, 1510 the level of noise and adjusts 1512, 1514 the trigger parameter in accordance with the measured noise level. When the timer exceeds the threshold time, the device 102 reinitializes 1502 the timer and again determines 1504 the stationary of the noise as the process repeats. By using the timer, the level of noise is determined more frequently than the stationary of the noise. For the illustrated methods 1500, the trigger parameter is checked, and adjusted, if necessary, every time the level of noise in the acoustic signal is determined. In an alternate embodiment, the stationarity of the noise is determined more frequently than the level of noise by nesting the determination of stationarity inside the determination of the noise level within the algorithm. In one case, the trigger parameter is adjusted in accordance with a first or second function of the stationarity of the noise, depending on the noise level.

In a specific embodiment, the first function used to adjust a trigger threshold or a trigger delay at 1512 includes a first step function of the noise level, and the second function used to adjust the trigger threshold or the trigger delay at 1514 includes a second step function of the noise level. As an example, when the device 102 determines 1506 the noise in the acoustic signal is stationary, the device 102 adjusts the trigger threshold for speaker verification in accordance with a two-level step function of the level of noise with a single transition point. When the device 102 determines 1506 the noise in the acoustic signal is non-stationary, the device 102 adjusts the trigger threshold for speaker verification in accordance with a three-level step function of the level of noise having two, a first and a second, transition points. Further, the noise level of the first and second transition points of the three-level step function are 3 dB and 6 dB higher, respectively, than the noise level of the single transition point for the two-level step function.

For another embodiment, the first function includes a first continuous function of the noise level, and the second function includes a second continuous function of the noise level. The first and second functions, for instance, can both be line segments on the operational domain of the device 102 that are defined by lines having different intercepts and slopes.

In the first of two additional embodiments, the first function includes a step function of the noise level, and the second function includes a continuous function of the noise level. In the second of the two embodiments, the step function and the continuous function are interchanged so that the first function includes a continuous function of the noise level, and the second function includes a step function of the noise level.

Returning again to FIG. 14, when the device 102 determines 1406 a motion profile 402, it also determines 1412 a motion environment profile 408 from the motion profile 402 and the noise profile 406. Based on the motion environment profile 408, the device 102 adjusts a trigger parameter at 1414, which in one embodiment, is a trigger threshold, and in another embodiment, is a trigger delay. As indicated by reference to FIG. 4, integrating data from the motion profile 402 with data from the noise profile 406 allows the device 102 to draw inferences from the different types of data to construct a more complete and accurate categorization of the noise in the acoustic signal and how the noise will affect voice recognition processing.

In an embodiment where the motion environment profile 408 indicates a transportation mode and whether the device is inside or outside, the device 102 is able to draw inferences about the type of noise it is being subjected to. The transportation mode and the indication of whether the device 102 is inside or outside is data integrated into the motion environment profile 408 from the motion profile 402. If the transportation mode indicates the device 102 is traveling in an automobile and the indoor/outdoor indication suggests the windows are rolled down, the device 102 infers that the noise in the acoustic signal includes road noise, which is stationary noise. Depending on the detection and categorization of any additional noise, the device 102 adjusts trigger parameters related to voice recognition accordingly.

The motion environment profile 408 can also be used to determine functions that define a trigger parameter value. For example, one set of functions can be used to adjust a trigger threshold for speaker verification while the device is traveling in a plane, whereas another set of functions can be used while the device is traveling in an enclosed car, even though the noise in both cases may be classified as stationary noise. Continuing this example, yet another set of functions can be used to adjust the trigger threshold for speaker verification when the device 102 determines that the car is not enclosed, such as when windows are open or a top is down.

In another embodiment, by integrating the motion 402 and noise 406 profiles, the motion environment profile 408 indicates whether the device 102 is in a private environment with fewer than a first threshold number of speakers or a public environment with greater than the first threshold number of speakers, wherein the trigger threshold is made less discriminating when the device 102 is determined to be in a private environment relative to when the device 102 is determined to be in a public environment. For a particular embodiment, the trigger threshold comprises at least one of: a trigger threshold for phoneme detection, a trigger threshold for phrase matching, or a trigger threshold for speaker verification. For a given level of noise, having fewer speakers lowers the likelihood of falsely triggering the voice recognition for the device 102.

For one embodiment, a trigger threshold for phrase matching is loosened (i.e., lowered) if it is determined that the device 102 is in an environment where the number of people speaking and other noise sources are limited, such as in an enclosed automobile. The loosening of the trigger threshold for phrase matching in such an environment will allow less voice utterances or phrases to be ignored due to noise conditions. False triggering in this instance is controlled because the trigger threshold for phrase matching is only opened up in noise-restricted environments, like the enclosed automobile.

For another embodiment, a trigger threshold for speaker verification may also be adjusted based on the integration of the motion 402 and noise 406 profiles. Enclosed environments, such as an automobile with the windows up, for example, offer less noise to interfere with speaker verification. This results in higher speaker verification scores that allow the trigger threshold for speaker verification to be increased to higher confidences. When speech is received in a reduced-noise environment, the device 102 can determine that the speech originated from an authorized user with a greater degree of certainty.

For a further embodiment, the motion environment profile 408 indicates whether the device 102 is in an environment that contains only a user of the device 102, wherein when at least one trigger threshold is a trigger threshold for speaker verification, the method 1400 further comprises disabling a speaker verification process that uses the trigger threshold for speaker verification. If the only person in proximity to the device 102 is an authorized user, then the device 102 infers, when the phrase matching trigger is tripped, that a recognized phrase is being received from the authorized user. This allows the device to reduce processing time and conserve power.

FIGS. 20 and 21 relate to alternate embodiments for the present disclosure. Specifically, embodiments in which a trigger threshold related to voice recognition processing is adjusted based on an increasing function of a noise characteristic (as opposed to decreasing function, as shown in FIGS. 16 and 17). The trigger threshold level is indicated at 2004 and 2104. In these alternate embodiments, the trigger threshold can be a trigger threshold for phoneme detection, a trigger threshold for phrase matching, and/or a trigger threshold for speaker verification, in addition to any other type of trigger threshold associated with voice recognition processing. The noise characteristic can be a noise level or the non-stationarity of noise, as shown at 2002 and 2102. The noise characteristic can also be a spectral characteristic of the noise, a distribution of noise levels or noise types across a range of frequencies, for example. Specifically, the graph 2000 shows the trigger threshold has a continuous functional dependence upon the noise characteristic 2002, wherein the continuous function 2006 is an increasing function of the noise characteristic 2002. Graph 2100 also shows an increasing functional dependence of the trigger threshold on the noise characteristic. The function 2106, however, is an increasing step function with a single transition point at 2108.

In further embodiments, different trigger thresholds associated with voice recognition processing are adjusted differently as one or more noise characteristics change. For example, one or more trigger thresholds might be increased as a result of increasing noise levels or a determination of non-stationarity while one or more other trigger thresholds might be simultaneously decreased under the same noise conditions. It might be the case, for example, that in the presence of higher noise levels, or a determination that the noise is non-stationarity, that the trigger threshold for phoneme detection is increased to “screen out” noise elements not associated with authorized speech. Simultaneously, the device 102 lowers the threshold for the phrase matching trigger 1206 so an authorized command results in a confidence score that is sufficient to trip the phrase matching trigger 1206 in the presence of the noise.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method performed by a device for adjusting a trigger parameter related to voice recognition processing, the method comprising:
receiving into the device an acoustic signal comprising a speech signal, which is provided to a voice recognition module, and comprising noise;
determining a noise profile for the acoustic signal, wherein the noise profile identifies a noise level for the noise and identifies a noise type for the noise; and
adjusting the voice recognition module based on the noise profile by adjusting a trigger parameter related to voice recognition processing.

2. The method of claim 1, wherein the noise type is determined based on at least one of:
a frequency spectrum for the noise; or
temporal information for the noise.

3. The method of claim 1, wherein the noise type comprises a stationarity of the noise, wherein the stationarity of the noise is determined based on time averages of energy for the noise on different time intervals for the noise.

4. The method of claim 1, wherein the trigger parameter comprises a trigger threshold.

5. The method of claim 4, wherein the trigger threshold comprises at least one of:
a trigger threshold for phoneme detection;
a trigger threshold for phrase matching; or
a trigger threshold for speaker verification.

6. The method of claim 4, wherein the trigger threshold is adjusted based on the noise level.

7. The method of claim 6, wherein the trigger threshold is adjusted based on at least one of a continuous function of the noise level or a step function of the noise level.

8. The method of claim 4, wherein the noise type comprises a stationarity of the noise, and the trigger threshold is adjusted based on the stationarity of the noise.

9. The method of claim 8, wherein the trigger threshold is made more discriminating when the noise is determined to be stationary relative to when the noise is determined to be non-stationary.

10. The method of claim 8, wherein the trigger threshold is made less discriminating when the noise is determined to be stationary relative to when the noise is determined to be non-stationary.

11. The method of claim 8, wherein the trigger threshold is further adjusted based on the noise level, wherein when the noise is determined to be non-stationary, the trigger threshold is adjusted based on a first function of the noise level, and when the noise is determined to be stationary, the trigger threshold is adjusted based on a second function of the noise level, wherein the first function is different than the second function, and the first function and second function comprises a combination of one of:
the first function comprises a first step function of the noise level, and the second function comprises a second step function of the noise level;
the first function comprises a first continuous function of the noise level, and the second function comprises a second continuous function of the noise level;
the first function comprises a step function of the noise level, and the second function comprises a continuous function of the noise level; or
the first function comprises a continuous function of the noise level, and the second function comprises a step function of the noise level.

12. The method of claim 4 further comprising:
determining a motion profile;
determining a motion environment profile from the noise profile and the motion profile, wherein the motion environment profile indicates at least one of a transportation mode or whether the device is inside or outside; and
further adjusting the trigger threshold based on the motion environment profile.

13. The method of claim 12, wherein the motion environment profile indicates whether the device is in a private environment with fewer than a first threshold number of speakers or a public environment with greater than the first threshold number of speakers, wherein the trigger threshold is made less discriminating when the device is determined to be in a private environment relative to when the device is determined to be in a public environment.

14. The method of claim 1, wherein the trigger parameter comprises a trigger delay, wherein the trigger delay is adjusted based on the noise level.

15. The method of claim 14, wherein the trigger delay is adjusted based on a decreasing function of the noise level such that a first trigger delay associated with a first noise level is greater than a second trigger delay associated with a second noise level when the second noise level is greater than the first noise level.

16. The method of claim 14, wherein the trigger delay is adjusted based on an increasing function of the noise level such that a first trigger delay associated with a first noise level is less than a second trigger delay associated with a second noise level when the second noise level is greater than the first noise level.

17. The method of claim 15, wherein the decreasing function of the noise level is a decreasing continuous function of the noise level or a decreasing step function of the noise level.

18. The method of claim 1, wherein the noise type comprises a stationarity of the noise, and the trigger parameter comprises a trigger delay, wherein the trigger delay is adjusted based on the stationarity of the noise.

19. The method of claim 18, wherein the trigger delay is adjusted based on a decreasing function of the non-stationarity of the noise such that a first trigger delay associated with a stationary noise is greater than a second trigger delay associated with a non-stationarity noise.

20. The method of claim 18, wherein the trigger delay is adjusted based on an increasing function of the non-stationarity of the noise such that a first trigger delay associated with a stationary noise is less than a second trigger delay associated with a non-stationarity noise.

21. The method of claim 19, wherein the decreasing function of the non-stationarity of the noise is decreasing continuous function of the non-stationarity of the noise or a decreasing step function of the stationarity of the noise.

22. A device configured to perform voice recognition, the device comprising:
at least one acoustic transducer configured to receive an acoustic signal comprising a speech signal and noise;
a voice-recognition module configured to perform voice recognition processing on the speech signal; and
a processing element configured to:
determine a noise profile for the acoustic signal, wherein the noise profile identifies a level and stationarity of the noise; and
adjust the voice recognition module by adjusting a trigger threshold related to voice recognition based on the noise profile, wherein the trigger threshold comprises at least one of a trigger threshold for phoneme detection, a trigger threshold for phrase matching, or a trigger for speaker verification.

23. The device of claim 22, wherein the processing element is further configured to:
adjust the at least one trigger threshold by making the at least one trigger threshold more discriminating when the noise is determined to be stationary relative to when the noise is determined to be non-stationary; or
adjust the at least one trigger threshold by making the at least one trigger threshold less discriminating when the level of noise is determined to be higher relative to when the level of noise is determined to be lower, wherein the adjusting is based on at least one of a step function of the level of noise or a continuous function of the level of noise.
